(19) United States
(12) Patent Application Publication
(10) Pub. No.: US 2024/0334544 A1
(43) Pub. Date: Oct. 3, 2024

(54) COMMUNICATIONS NETWORKS WITH REDUNDANCY DIVERSITY

(71) Applicant: Catalyst Communications Technologies, Inc., Forest, VA (US)

(72) Inventors: John M Schools, Forest, VA (US); Robin Grier, Forest, VA (US)

(73) Assignee: Catalyst Communications Technologies, Inc., Forest, VA (US)

(21) Appl. No.: 18/621,845

(22) Filed: Mar. 29, 2024

Related U.S. Application Data
(60) Provisional application No. 63/468,284, filed on May 23, 2023.
(60) Provisional application No. 63/455,589, filed on Mar. 30, 2023.

(51) Int. Cl. H04W 76/45; H04W 40/12; H04W 76/14

(52) U.S. Cl. CPC H04W 76/45; H04W 40/12; H04W 76/14

(57) ABSTRACT

Techniques for communication based on communication networks with redundancy diversity are disclosed. Push-to-talk services are accessed over a first communications system. The first communications system includes at least two homogeneous groups. The homogeneous groups enable redundancy for the first communications system. Additional push-to-talk services are provided over a second communications system. The second communications system implements a different network protocol from the first communications system. At least one homogeneous group is included in the second communications system. A peer-to-peer connectivity is established between the first communications system and the second communications system. Data for a communication channel is routed between a first group in the first communications system and a group in the second communications system. The data is rerouted between a second group in the first communications system and the group in the second communications system, based on the data and the peer-to-peer connectivity.

### RELATED APPLICATIONS

This application claims the benefit of U.S. provisional patent application “Communication Networks With Redundancy Diversity” Ser. No. 63/455,589, filed Mar. 30, 2023 and “Communications Networks Using Situational Inference” Ser. No. 63/468,284, filed May 23, 2023.

Each of the foregoing applications is hereby incorporated by reference in its entirety.

### FIELD OF ART

This application relates generally to communications and more particularly to communications networks with redundancy diversity.

### BACKGROUND

The invention of wireless communications devices and techniques has enabled the transfer of information over distances long, medium, and short. Primitive “wireless” techniques advanced from semaphores and signal fires to systems that could be used day or night and under various weather conditions. Early systems for wireless information transfer included the “photophone” which transferred audio using light. Electromagnetic induction systems were extensively researched for their communication capabilities. An electromagnetic system was developed to couple a moving train to nearby telegraph cables, but these early electromagnetic systems were useful only over short distances. Electrical systems were investigated for wireless telegraphy. These wireless telegraphic systems were based on ideas including sending a current through a medium such as water or the ground. Unsurprisingly, these wireless systems were only useful over short distances. It was not until radio waves were used as a basis for the telegraphic systems that a major wireless breakthrough occurred. Using radio waves, information could be transferred over both short distances and long distances, and to more than one recipient at a time. Significant interest resulted, as radio waves were used to communicate messages of various types, including routine messages, military messages, and emergency messages, among many other types.

Radio wave transmitters and receivers from the early days were primitive devices. The transmitter included a spark gap that caused a spark to arc between two electrodes. These transmitters generated many frequencies, including audio, radio, and even light. Spark gap signals were detected using a device called a coherer. This device used metal particles between two electrodes. When a signal was detected, the metal particles would form a bridge between the electrodes, enabling an electric current to flow. Improved radio transmission and reception resulted from the development of transmitters that could transmit on a selected frequency and receivers that could selectively detect that frequency. Thus, continuous wave or CW signals could be transmitted to relay Morse code messages. Modulation techniques were developed for transmission of audio signals. These modulation techniques included amplitude modulation (AM), followed by frequency modulation (FM).

Transmission and reception techniques for radio signals have rapidly advanced. These techniques have accessed increasingly higher frequency bands, thereby providing a wider frequency range for sending and receiving wireless communications. These techniques further enable an increasing number of signals to be transmitted. New analog and digital modulation techniques have also been developed. These new techniques take advantage of the expanded radio frequency spectrum available for communication. Such modulation techniques include amplitude shift keying (ASK), frequency shift keying (FSK), and quadrature shift keying (QSK), among many variants. Perhaps the most interesting modulation technique is based on spread spectrum techniques. Originally developed to hinder both detection and jamming in military wireless applications, spread spectrum techniques are now widely used for common civilian applications such as cellular telephony.

### SUMMARY

Various radio transmission and reception techniques are used to transfer information over distances that range from a few millimeters to thousands of kilometers. The radio spectrum, which is a portion of the wider electromagnetic spectrum, is generally considered to include frequencies between 0 Hz (e.g., DC) and 3 THz. The radio spectrum is divided into sections, or frequency “bands”. The various frequency bands can propagate to different locations around the earth, into space, and beneath the oceans. As a result, the frequency bands are assigned to specific communications services. The frequency band assignments to particular communications services are overseen by the International Telecommunication Union (ITU), individual governments, government agencies such as the Federal Communications Commission (FCC), and so on. Competition for the frequency bands is fierce. Groups that use the bands demand expanded band access by arguing that other users underutilize their allocations. From time to time, controlling organizations run auctions to sell off portions of a radio frequency (RF) band to commercial enterprises for purposes ranging from cellular communications to digital television, and to wireless devices such as microphones, among many other applications. Some RF bands are reserved for specific purposes such as business terrestrial communications, maritime communications, government communications, experimentation, etc. Within a government band, for example, the band can be partitioned and assigned to various governmental agencies such as public safety, emergency services, the military, etc.

While assigning frequencies, even within a band, to different agencies can be argued from an organizational or sharing perspective, such assigning has resulted in limited or no communications interoperability between user agencies and the user devices employed by the agencies. This situation often results when the agencies use various communications systems, channels, access codes, etc. While a few usage scenarios can be appreciated in which use of divergent channels, user devices, and so on remain desirable (e.g., to relieve network congestion or for secure operation purposes), more generally, communications system interoperability is highly desirable. However, providing communications system interoperability is an expensive and resource intensive undertaking. Enabling communications between communications systems typically requires developing and maintaining the interoperability capabilities. The interoperability between communications systems, and by extension the associated user devices, includes routing data between the communications systems. The data includes voice data, status data, and metadata. The data can also include text, individual voice calls, and talkgroup calls. The routing the data can further provide useful information such as Talker ID, global positioning system (GPS) location, and critical information such as mission-critical data (MCData). If a link between communications systems becomes unreliable, unreachable, or fails, or a group within a first communications system can no longer communicate with a group in a second communications system, then the data can be rerouted. The groups associated with each communications system, and “backup” and redundant links between the communications systems, enable communications system redundancy diversity.

Communications are accomplished using communications networks with redundancy diversity. Push-to-talk (PTT) services are accessed over a first communications system, wherein the first communications system includes at least two homogeneous groups, and wherein the at least two homogeneous groups enable redundancy for the first communications system. Additional push-to-talk (PTT) services are provided over a second communications system, wherein the second communications system implements a different network protocol from the first communications system, and wherein at least one homogeneous group is included in the second communications system. A peer-to-peer connectivity is established between the first communications system and the second communications system. Data for a communication channel is routed between a first group in the first communications system and a group in the second communications system. The data is rerouted between a second group in the first communications system and the group in the second communications system, based on the data and the peer-to-peer connectivity.

A computer-implemented method for communications is disclosed comprising: accessing push-to-talk (PTT) services over a first communications system, wherein the first communications system includes at least two homogeneous groups, and wherein the at least two homogeneous groups enable redundancy for the first communications system; providing additional push-to-talk (PTT) services over a second communications system, wherein the second communications system implements a different network protocol from the first communications system, and wherein at least one homogeneous group is included in the second communications system; establishing a peer-to-peer connectivity between the first communications system and the second communications system; routing data for a communication channel between a first group in the first communications system and a group in the second communications system; and rerouting the data between a second group in the first communications system and the group in the second communications system, based on the data and the peer-to-peer connectivity. In embodiments, each group of the first communications system and each group of the second communications system comprises a server with a client link and a server link to each other group. In embodiments, the client link and the server link comprise a link pair. In embodiments, the link pair enables peer-to-peer connectivity between two groups. In embodiments, the data comprises voice data, status data, and metadata. In embodiments, the voice data and the metadata only flow on an active link pair. And in embodiments, the status data flows on active and inactive link pairs.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for communication networks with redundancy diversity.

FIG. 2 is a flow diagram for enabling communication networks with redundancy diversity.

FIG. 3 shows two-way communication between communications systems and groups.

FIG. 4 is system configuration for arbitrating redundancy.

FIG. 5 is a system configuration for arbitrating redundancy.

FIG. 6 is an infographic for a first and second homogeneous communications system.

FIG. 7 is a system diagram for communication networks with redundancy diversity.

### DETAILED DESCRIPTION

Techniques for communication based on communications networks with redundancy diversity are disclosed. Radio, which is based on propagation of electromagnetic waves, has enabled techniques for wireless communications over distances long, medium, and short. The radio frequency (RF) spectrum, which is generally defined as 0 Hz to 3 THz, is divided into various bands. The bands each include various propagation characteristics, bandwidths, data transmission rates, and so on, thereby lending themselves to different communications capabilities. The extremely low frequency band (ELF) and very low frequency band (VLF), which can include frequencies between 3 Hz and 30 Hz and 3 kHz and 30 kHz respectively, can be used to communicate with submerged submarines. However, for these bands, antenna systems are very large and data transmission rates are very low. At the other end of the RF spectrum, microwaves, which can include frequencies between 1 GHz and 1000 GHZ (1 THz), can transmit very large amounts of data using small antennas or dishes. Microwave communications tend to be used for high bandwidth, line-of-sight applications over relatively short distances because the signals attenuate rapidly over distance, disperse in rain and snow, etc. Because of these vastly different capabilities, use of the various RF bands is regulated by international organizations such as the International Telecommunications Union (ITU), treaties among countries, individual governments, government agencies such as the Federal Communications Commission (FCC), and the like. There are many competing public, private, and other uses for the RF bands, including AM broadcast, shortwave, aviation, and government. Public safety, business, FM broadcast, digital television, emergency broadcast such as NOAA Weather Radio (NWR) All Hazards, cellular telephony, and satellite links, among many, many more, also compete for RF bands. Some of the bands are also used for gathering scientific data.

A wide variety of public services, such as fire, police, and emergency medical services, are often assigned different frequencies or “channels” within a band. The assignments are made to reduce channel congestion, to enable communication to proceed without causing unrelated or unnecessary transmissions to interfere with the other services, and so on. Further, the public service channels can be assigned within different bands such as the very high frequency (VHF) and ultra-high frequency (UHF) bands. As a result, communications within a department or agency, let alone communications between departments and agencies, can be incompatible, difficult, or impossible. Although continuing progress for interservice or interagency interoperability is being made, particularly in the wake of the September 11 terrorist attacks and Hurricane Katrina, the interagency communications remain highly problematic. Law enforcement agencies such as state and local police, ATF, FBI, and emergency medical services still encounter interagency communication issues. These issues tragically continue to hinder responses to emergency situations such as active shooter events. When communication between communications systems such as agency communications systems are enabled, communications such as text messages, individual voice calls, talkgroup voice calls, videos, and file sharing, etc. can be routed between groups associated with the agencies. Further, when a data link fails, becomes unreliable, or is found to be unreachable, then the data can be rerouted using a redundant peer-to-peer connectivity route.

Communications are accomplished based on communications networks with redundancy diversity. Push-to-talk (PTT) services are accessed over a first communications system. The PTT services can include text messaging, individual voice calls, talkgroup voice calls, video sharing, file sharing, and so on. The first communications system can be accessible using a plurality of user devices. The user devices can include handheld transceivers (HTs), mobile transceivers, base station transceivers, software-defined radio (SDR) transceivers, and so on. The first communications system includes at least two homogeneous groups. Each group can include a server with a client link and a server link to each other group. The client link and the server link, or “link pair”, enables peer-to-peer connectivity between two groups. The at least two homogeneous groups enable redundancy for the first communications system. If one of the groups becomes too busy, unreliable, unreachable, or fails, then a redundant group can be used. Additional push-to-talk (PTT) services are provided over a second communications system. The second communications system can be associated with a second service or agency, can have a separate user base, etc. The second communications system implements a different network protocol from the first communications system. The communications systems can be based on protocols such as Long Term Evolution (LTE) cellular, Land Mobile Radio (LMR), and so on. At least one homogeneous group is included in the second communications system. The homogeneous group can be associated with a wireless provider. A peer-to-peer connectivity is established between the first communications system and the second communications system. The peer-to-peer connectivity is enabled by a link pair associated with a server. The peer-to-peer connectivity determines active communication channels among the groups. Data for a communication channel is routed between a first group in the first communications system and a group in the second communications system. The data can include voice data, status data, and metadata. The data can further include video data and data files. The data is rerouted between a second group in the first communications system and the group in the second communications system, based on the data and the peer-to-peer connectivity. The rerouting can be performed automatically. The rerouting occurs due to a change in communication channel availability or communication channel status such as unreliable, unreachable, etc. The rerouting provides a redundant communication channel.

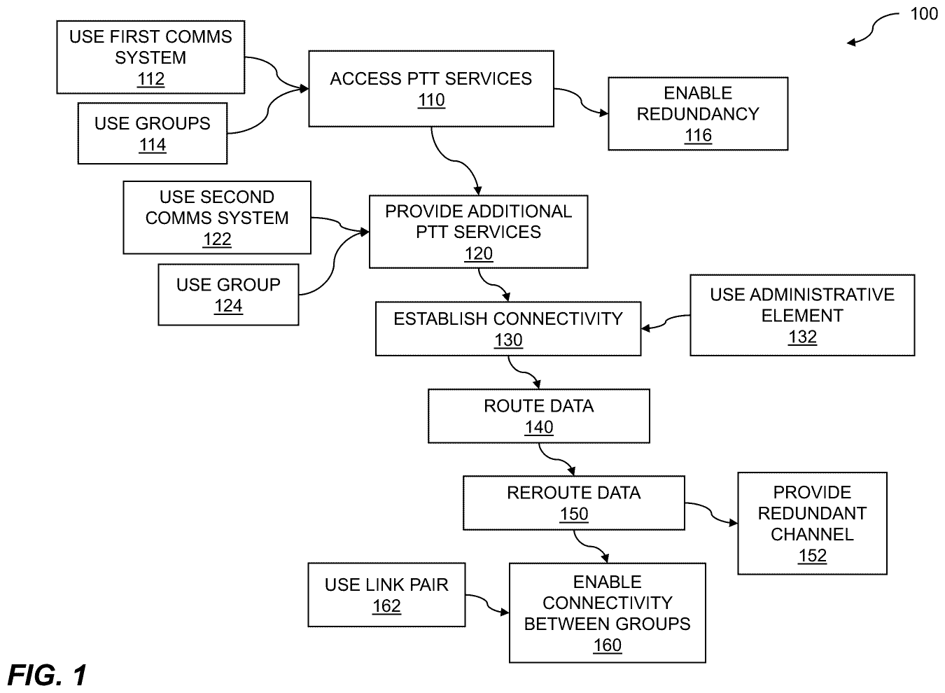

FIG. 1 is a flow diagram for communications networks with redundancy diversity. Communications systems can be established to enable the exchange of voice calls, text messages, and so on among users of a communications system. The users can include amateur radio operators; subscribers; team members associated with an organization or service such as public safety, government agencies, and emergency medical services; and so on. The communications systems can be accessed using a standard device configured to operate with the service, supplemental hardware, an application, and so on. A user of a first communications system can communicate with a user of a second communications system when there is link established between the first communications system and the second communications system. The link can enable the transfer of text messages, individual calls, and talkgroup calls between the two communications systems. Data is routed for a communication channel between a first group in the first communications system and a group in the second communications system. The routing data is accomplished using a link pair between the first group and the second group. At times, links between communications systems can become overloaded, can become unstable or unreliable, can fail, and so on. To ensure reliable communication between the communications system, redundant groups can be established within each group. The redundant groups can be configured and idling, thereby remaining at the ready to be placed into service if the first link performance is unacceptable. The data is rerouted between a second group in the first communications system and the group in the second communications system, based on the data and the peer-to-peer connectivity. The rerouting provides a redundant communication channel. The data can further include a Talker ID, GPS coordinates, mission-critical information, and so on.

The flow 100 includes accessing push-to-talk (PTT) services 110. A PTT service can enable two-way communication between a transmitting device and one or more receiving devices. The PTT service can be based on a communications model such as a half-duplex model. A half-duplex model can enable transmitting and receiving on a channel with one transmitter and one or more receivers. One transmitter can transmit at a time. The PTT service can support one or more subaudible tones, tone codes, and so on. The tones can be used to open squelch, enable access to a channel, and so on. The PTT service can support a repeater operation, where a repeater operation can be based on a shift or offset between a transmitting frequency and a receiving frequency. The transmitter can transmit to the repeater on an offset frequency with respect to the receiving frequency, thereby enabling substantially simultaneous transmission and reception.

In the flow 100, the PTT services are accomplished using a first communications system 112. The first communications system can be based on a variety of wireless communications protocols. In embodiments, the first communications system can include homogeneous groups each based on cellular protocols. The cellular protocols can include standard cellular protocols. The cellular protocols can include Third Generation Partnership Project (3GPP) protocols. In embodiments, the cellular protocols can include long-term evolution (LTE) protocols. The LTE technology can include 4G technology, 5G technology, and the like. Other 3GPP-compliant devices can include GSM, UMTS, IP Multimedia Subsystem (IMS), etc. In the flow 100, the first communications system includes at least two homogeneous groups 114. The homogeneous groups can include redundant groups based on substantially similar protocols. In embodiments, the at least two groups can include redundant LTE groups. In the flow 100, the at least two homogeneous groups enable redundancy 116 for the first communications system. Discussed below, a group within the first communications system can communicate with a group in another communications system. If one of the at least two homogeneous groups becomes unable to handle data or fails, then another of the at least two homogeneous groups can be used instead.

The flow 100 includes providing additional push-to-talk (PTT) services 120 over a second communications system. As for the first communications system, the PTT service can enable two-way communication between a transmitting device and one or more receiving devices. The PTT service can be based on a communications model such as a simplex (e.g., one direction), a half-duplex model (e.g., both directions, one at a time), and so on. The PTT service can support one or more subaudible tones, tone codes, and so on. The PTT services associated with the second communications system can support a repeater operation. In the flow 100, the second communications system 122 implements a different network protocol from the first communications system. In embodiments, the second communications system can include homogeneous groups each based on Land Mobile Radio (LMR) protocols. LMR technology can access assigned frequencies within radio frequency (RF) bands. The radio bands can include low-VHF, VHF, UHF bands, and so on. LMR radio technology can be used by public safety officers, emergency medical services, and the like. In embodiments, the first communications system can include a plurality of user devices. The user devices can include transceiver devices configured to operate with the first communications system. The user devices can include handheld transceiver (HT), mobile transceiver, and base station transceiver devices. The PTT service can be provided using various PTT over broadband capabilities. In the flow 100, at least one homogeneous group is included 124 in the second communications system. The at least one homogeneous group can include an LMR group independently provided by an enterprise. In embodiments, the homogeneous groups based on LMR protocols can include systems from two or more different vendors. Further embodiments can include at least two homogeneous groups in the second communications system. The at least two homogeneous groups can be based on different LMR channels, configurations, access codes, etc. In other embodiments, the at least two homogeneous groups in the first communications system and the at least two homogeneous groups in the second communications system can enable dynamic, multi-system redundancy. The LMR protocols can support long, medium, and short distance communications. In other embodiments, the second communications system can include homogeneous groups each based on near field communication (NFC) protocols.

The flow 100 includes establishing a peer-to-peer connectivity 130 between the first communications system and the second communications system. The peer-to-peer connectivity can be established using a link between the first communications system and the second communications system. In embodiments, each group of the first communications system and each group of the second communications system can include a server with a client link and a server link to each other group. The links can enable sharing of data, communications system configurations, and so on. In embodiments, the client link and the server link can comprise a link pair. The link pair can include a wired, a wireless, or a hybrid wired and wireless connection; an internet connection; etc. In embodiments, the peer-to-peer connectivity can determine active communication channels among the groups. Recall that each communications system can include at least one group. Links can be established between each group in the first communications system and each group in the second communications system. The links can include an active link and one or more inactive links. In embodiments, the determining can be based on active communication channel availability and communication channel status. Communications channel status can include available, ready, busy, intermittent, fading, unreachable, etc. The flow 100 further includes using an administrative element 132 to initially configure the peer-to-peer connectivity. An initial configuration can be provided using a console. The initial configuration can be entered by an operator or administrator, generated based on an artificial intelligence (AI) model, and so on.

The flow 100 includes routing data 140 for a communication channel between a first group in the first communications system and a group in the second communications system. The routing can be accomplished based on the peer-to-peer connectivity established between the first communications system and the second communications system. Various types of data can be routed between a first group in the first communications system and a group in the second communications system. In embodiments, the data can include voice data, status data, and metadata. The data can further include video data, data files, and the like. The voice data can include voice data between a user device associated with a group in the first communications system and a user device associated with a group in the second communications system. The voice data can include a talk group voice data. The status data can include group status, link pair status, channel status, etc. The metadata can include a Talker ID or identifier, GPS location information, mission-critical information, and the like. In embodiments, the voice data and the metadata can only flow on an active link pair. The status data can flow differently. In embodiments, the status data can flow on active and inactive link pairs.

The flow 100 includes rerouting the data 150 between a second group in the first communications system and the group in the second communications system, based on the data and the peer-to-peer connectivity. The data can be rerouted due to changes in channel integrity, channel traffic, channel jamming, equipment failure, and so on. In embodiments, the rerouting can occur due to a change in communication channel availability or communication channel status. A channel can become unavailable due to an organizational or service directive, equipment failure, the inclusion of additional services, etc. In embodiments, the communication channel status can include information about a group connected to the communication channel. The group can include law enforcement, fire services, emergency response teams, medical teams, and so on. In the flow 100, the rerouting provides a redundant communication channel 152. The redundant communication channel can include a communication channel configured substantially similarly to the primary communication channel. The redundant communication channel can include a backup channel, an auxiliary channel, etc. In embodiments, the peer-to-peer connectivity and the rerouting can enable PTT redundancy diversity. The redundancy diversity can significantly improve communications system availability, reliability, and so on.

In the flow 100, peer-to-peer connectivity is enabled 160 between two groups. The connectivity can include two-way communication between a group associated with the first communications system and a group associated with the second communications system. In the flow 100, the connectivity is accomplished using a link pair 162. The link pair can include a wired connection, a wireless connection, a hybrid wired and wireless connection, etc. The link pair can include an internet connection between servers associated with the groups. Discussed above, the peer-to-peer connectivity can determine active communication channels among the groups.

Various embodiments of the flow 100 can be included in a computer program product embodied in a non-transitory computer readable medium that includes code executable by one or more processors.

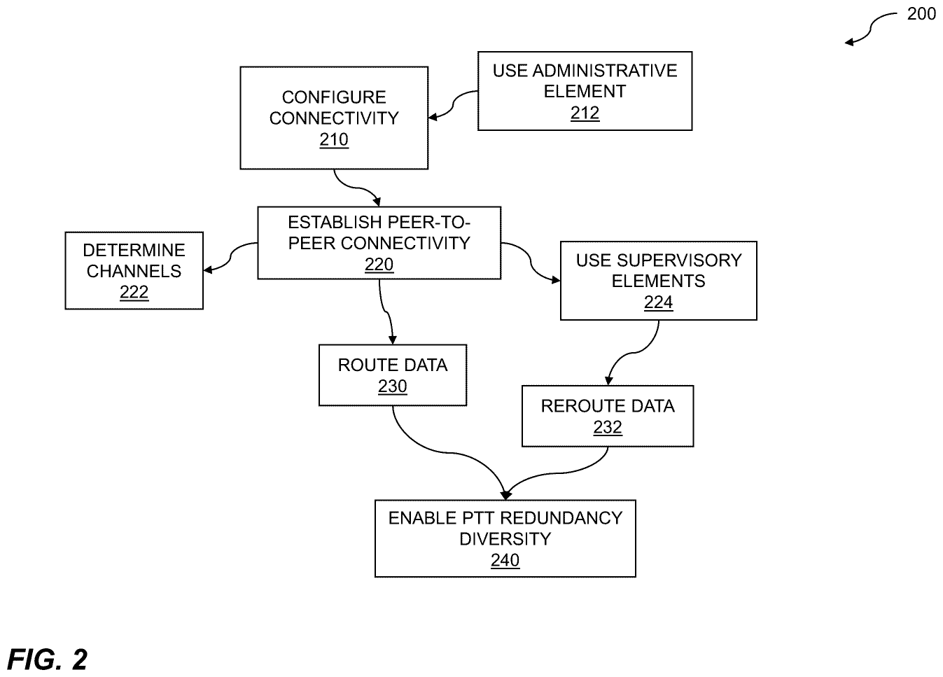

FIG. 2 is a flow diagram for enabling communication networks with redundancy diversity. Discussed throughout, communications can be established between user devices associated with different communications systems. The communications systems can include systems based on different communications protocols, channels, frequencies, bands, and so on. Further, the communications systems can be independently operated by government agencies, emergency services, corporations, and the like. Establishing communications between and among independent communications systems is critical to effective communication during times of crisis such as natural disasters, terrorist attacks, and government actions. Such communication can be enabled by deep integration between the communications systems. Such deep integration is difficult to implement and maintain and is typically and strongly resisted by the operators of the communications systems because the systems are operated independently. Instead, peer-to-peer connectivity can be established between communications systems. The peer-to-peer connectivity can be based on accessing and providing capabilities of push-to-talk compliant clients and specialized apps. The communications can be established between servers associated with homogeneous groups, where the homogeneous groups can be associated with different communications systems. Each server can use links, such as a client link and a server link, to enable peer-to-peer connectivity between the groups. These “link pairs” can be used to route data for a communication channel between one communications system and another communications system.

The data that can be routed for a communication channel can include voice data, status data, metadata, and so on. The data can include important information such as a Talker ID, mission-critical data, GPS data, etc. Such data as a Talker ID and a GPS position can provide additional information about a caller from a communications system which is different from the system receiving the call. Communications are enabled by communication networks with redundancy diversity. Push-to-talk (PTT) services are accessed over a first communications system, wherein the first communications system includes at least two homogeneous groups, and wherein the at least two homogeneous groups enable redundancy for the first communications system. Additional push-to-talk (PTT) services are provided over a second communications system, wherein the second communications system implements a different network protocol from the first communications system, and wherein at least one homogeneous group is included in the second communications system. A peer-to-peer connectivity is established between the first communications system and the second communications system. Data for a communication channel is routed between a first group in the first communications system and a group in the second communications system. The data is rerouted between a second group in the first communications system and the group in the second communications system, based on the data and the peer-to-peer connectivity.

The flow 200 includes configuring 210 peer-to-peer connectivity. The configuring can include activating a link pair comprising a client link and a server link. The configuring can further include making inactive additional link pairs, where the additional link pairs can provide links between servers. A link pair can used to route data between a group associated with a first communications system and a group associated with a second communications system. The servers can be associated with an additional group associated with the first communication system, an additional group associated with the second communications system, and the like. In embodiments, links can be established between each group associated with the first communications system and any group associated with the second communications system. The configuring can further include selecting one or more of communications vendors, communications protocols, user device types, access codes, squelch codes such as continuous tone-coded squelch system (CTCSS), subaudible tones, data compression techniques, data encryption techniques, and so on. In the flow 200, initial configuring is accomplished using an administrative element 212. The administrative element can include hardware, software, hybrid hardware-software, and so on. The administrative element can be programmed by a user, controlled based on an artificial intelligence (AI) model, and the like. The configuring can be accomplished using a console. The configuration information can be provided to a server. The configuration information can be shared among a group of servers.

The flow 200 includes establishing peer-to-peer connectivity 220 between the first communications system and the second communications system. The peer-to-peer connectivity can include connectivity using a link pair. A link pair can include a client link and a server link between a group such as a homogeneous group associated with the first communications system and a homogeneous group associated with the second communications system. In embodiments, the link pair can enable peer-to-peer connectivity between two groups. The link pair can be used to enable data flow between the two groups, where the data can include voice data; image or video data or files; status data such as server, link pair, or channel status; metadata such as Talker ID, GPS, or mission-critical information; and so on. In embodiments, the mission-critical information can include call priority and call preemption, emergency status, etc. In the flow 200, the peer-to-peer connectivity determines active communication channels 222 among the groups. The channels can include standardized channels associated with radio bands, government assigned channels, authorized channels, tactical or “Tac” channels, and so on. The channels can include channels associated with modulation techniques such as FM, narrow-band FM, and the like. The channels can include analog channels, digital channels, etc. In embodiments, the determining can be based on active communication channel availability and communication channel status. The communication channel can include an unused or priority channel, an assigned channel, etc. The channel status can include reliability, transmission quality, minimal fade or interference, and the like.

The flow 200 includes routing data 230 for a communication channel between a first group in the first communications system and a group in the second communications system. The routing data can include a bidirectional data flow. Recall that the data can include voice data, status data, and metadata. The data can further include images, videos, data files, etc. As discussed above, the routing the data can be based on channel assignment, priority, preemption level or rank, channel availability, and so on. The flow 200 further includes rerouting the data 232 between a second group in the first communications system and the group in the second communications system, based on the data and the peer-to-peer connectivity. The rerouting can be performed to reduce a communication load on a server; to replace a server which has failed, is unreliable, or is unreachable; etc. In embodiments, the rerouting can occur due to a change in communication channel availability or communication channel status. The communication channel over which the data was routed previously can become busy, unreliable, or intermittent; can fail; and the like. The rerouting can be performed by local supervisory elements 224 running on each of the servers. Because of the peer-to-peer connectivity that was established among the servers, communications reliability can be monitored and “passed” around the network among each server running the local supervisory function. A global administrator element can set up initial redundancy rules between and among servers, but the servers themselves contain the local supervisory switching function that is monitoring and switching between primary and redundant elements based on data communicated over the peer-to-peer connectivity. This occurs in a distributed fashion, and thus, while some servers, or gateways, may be “primary” and others “backup”, the local supervisory functions can control the routing among the servers to optimize the best reliability, channel data performance, service level agreement, cost, and so on. While the global administrator function can intervene and override the local supervisory function, disclosed concepts enable the servers themselves to find the best, most reliable path in an automatic fashion.

In the flow 200, the peer-to-peer connectivity and the rerouting enable PTT redundancy diversity 240. The redundancy diversity is accomplished by providing redundant servers associated with groups associated with the first communications system and with groups associated with the second communications system. The redundancy diversity is accomplished by accessing redundant or backup link pairs, spare or alternate communication channels, and the like. The redundancy diversity is further accomplished by enabling multiple, homogeneous groups in the first communications system and the second communications system. Further embodiments include at least two homogeneous groups in the second communications system. The homogeneous groups can be based on communications protocols provided by different communications vendors. In embodiments, the at least two homogeneous groups in the first communications system and the at least two homogeneous groups in the second communications system can enable dynamic, multi-system redundancy. The routing and rerouting of data can happen “on the fly” based on changing channel conditions, communications infrastructure availability such as repeater availability, etc.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

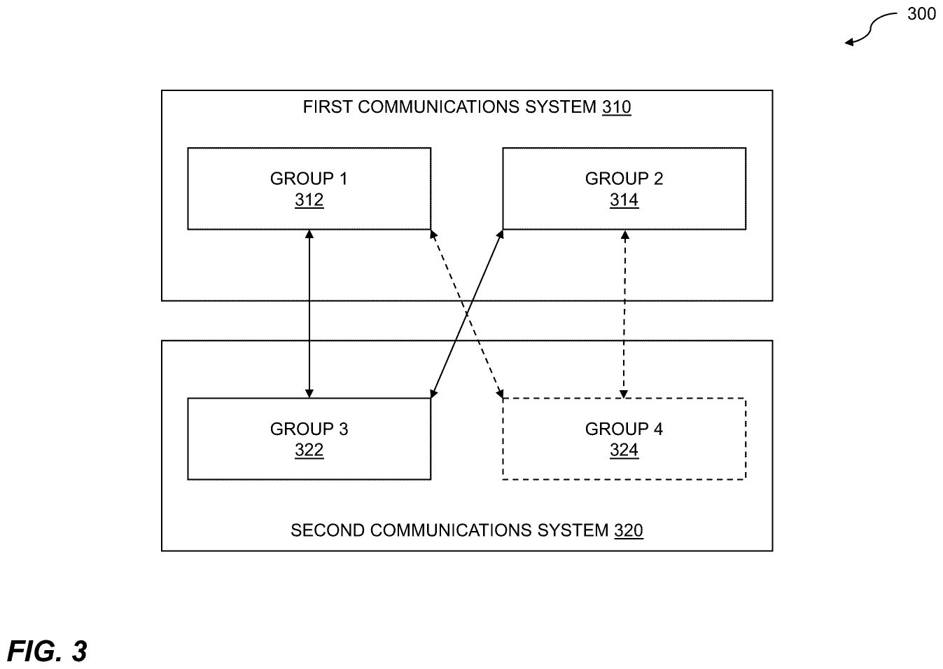

FIG. 3 shows two-way communication between communications systems and groups. The communications systems can be based on various communications techniques, standards, protocols, and so on. The communications systems can include wireless communications systems. Each communications system can include one or more groups. The groups can include homogeneous groups, where the homogeneous groups can be configured to use one or more channels; control and access tones, data compression and encryption techniques and keys; and so on. User devices configured to operate within a homogeneous group can enable communication among other peers within the group. The user devices can further be configured to engage in communication with more than one other user device. Communication with more than one other user device can include communications within a talk group. Communications can be established within a homogeneous group, between homogeneous groups associated with a communications system, between communications systems, between a group associated with a first communications system and a group associated with a second communications system, and so on. Communication between communications systems and groups enable communication networks with redundancy diversity. Push-to-talk (PTT) services are accessed over a first communications system, wherein the first communications system includes at least two homogeneous groups, and wherein the at least two homogeneous groups enable redundancy for the first communications system. Additional push-to-talk (PTT) services are provided over a second communications system, wherein the second communications system implements a different network protocol from the first communications system, and wherein at least one homogeneous group is included in the second communications system. Peer-to-peer connectivity is established between the first communications system and the second communications system. Data for a communication channel is routed between a first group in the first communications system and a group in the second communications system. The data is rerouted between a second group in the first communications system and the group in the second communications system, based on the data and the peer-to-peer connectivity.

Two-way communication is shown between communications systems with groups 300. A first communications system 310 can include one or more groups. The communications system can be based on a wireless communications technique. The wireless techniques can include cellular techniques. The wireless techniques can further include mobile radio techniques. The first communications system 310 can include homogeneous groups such as group 1 312 and group 2 314. In embodiments, the homogenous groups can enable redundancy for the first communications system. The redundancy can enable communication to and from the first communications system in the event of one of the homogeneous groups failing, becoming unavailable or unreliable, etc. In embodiments, the first communications system can include homogeneous groups each based on cellular protocols. Various cellular protocols can be supported. In embodiments, the cellular protocols can include long-term evolution (LTE) protocols, 5G protocols, etc. The second communications system 320 can include homogeneous groups such as group 3 322 and group 4 324. While two groups are shown, other numbers of groups can be associated with a communications system. In embodiments, the second communications system can include homogeneous groups each based on Land Mobile Radio protocols (LMR). The LMR protocols can be supported in various frequencies, channels, radio bands, and the like. The LMR protocols can include standard, open, or proprietary protocols, etc. In embodiments, the homogeneous groups based on LMR protocols can include systems from two or more different vendors. The communications systems can include channels, frequencies, radio bands, etc. that can be used for communications over various distances. The radio bands, for example, can support communications over meters, kilometers, tens of kilometers, and so on. The radio bands and techniques can support short range communications. In embodiments, the second communications system can include homogeneous groups each based on near field communication (NFC) protocols.

Each group associated with the first communications system can be coupled to each group associated with the second communications system using a server. In embodiments, each group of the first communications system and each group of the second communications system can include a server with a client link and a server link to each other group. The client link and the server link can include a wired link, a wireless link, a hybrid wired and wireless link, and the like. In embodiments, the client link and the server link can include a link pair. The link pair can enable two-way communications between groups. In embodiments, the link pair can enable peer-to-peer connectivity between two groups. The peer-to-peer connectivity can enable connectivity between a user device associated with a first group and a user device associated with a second group. The connectivity can also include talk groups between the first and second group. Discussed previously and throughout, the connectivity enables data flow between the groups via the link pair. In embodiments, the data can include voice data, status data, and metadata. The voice data and the metadata can flow on an active link pair. The status data can flow on an active link pair and on an inactive link pair. In the figure, active links can be configured between group 1 and group 3, and between group 2 and group 3, and shown by a solid line. Group 4 can include a redundant group associated with the second communications system. The link between group 1 and group 4, and the link between group 2 and group 4 (indicated by a dashed line) can be configured to be inactive in order to share status data. If group 3 were to fail or become unreachable or unresponsive, then linked redundant group 4 can be enabled, and links to group 3 can be disabled.

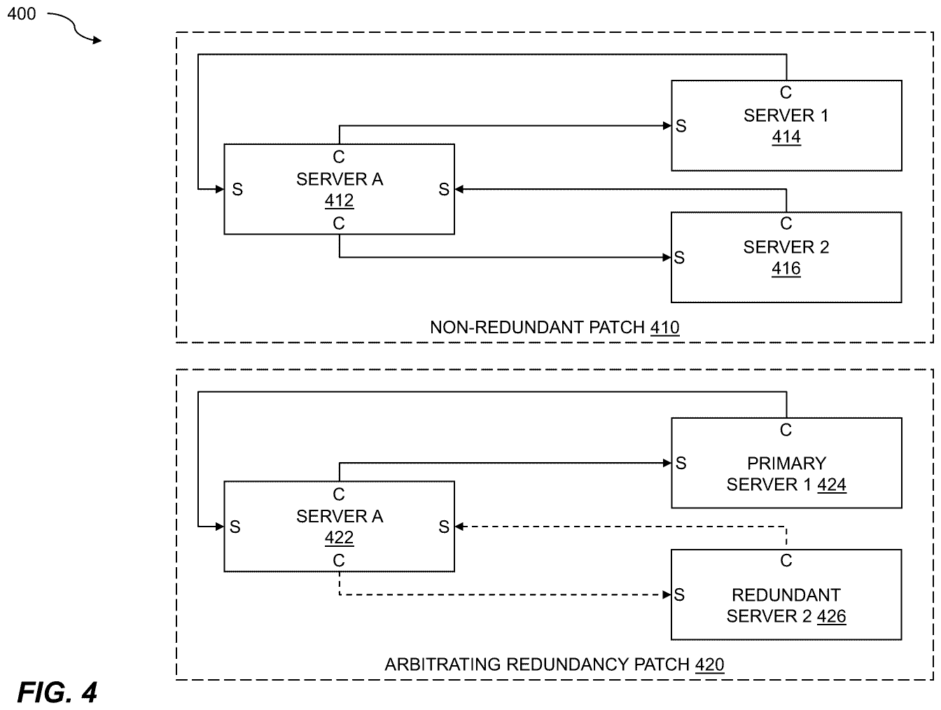

FIG. 4 is system configuration for arbitrating redundancy. Discussed throughout, peer-to-peer connectivity can be established between a first communications system and a second communications system. The communications systems can include at least one group. Each group of the first communications system and each group of the second communications system can include a server with a client link and a server link to each other group. The client link and the server link can include a link pair, and the link pair can enable peer-to-peer connectivity between two groups. The servers can be giving patching instructions by one or more clients, where the clients can comprise a console. The patching instructions can indicate which servers in the first communications system can be coupled to which servers in the second communications system. After the patching instructions are received from a console, the servers can thereafter coordinate all patch operations with peer servers. The patching instructions can include non-redundant patching instructions and redundant patching instructions. The arbitrating of the patching, and thereby the arbitrating of redundancy, can be overridden by an administrative element that initially configured the peer-to-peer connectivity. The arbitrating redundancy enables communication networks with redundancy diversity. Push-to-talk (PTT) services are accessed over a first communications system, wherein the first communications system includes at least two homogeneous groups, and wherein the at least two homogeneous groups enable redundancy for the first communications system. Additional push-to-talk (PTT) services are provided over a second communications system, wherein the second communications system implements a different network protocol from the first communications system, and wherein at least one homogeneous group is included in the second communications system. A peer-to-peer connectivity is established between the first communications system and the second communications system. Data for a communication channel is routed between a first group in the first communications system and a group in the second communications system. The data is rerouted between a second group in the first communications system and the group in the second communications system, based on the data and the peer-to-peer connectivity.

Two system configurations for arbitrating redundancy are shown 400. A system configuration can be based on a non-redundant patch 410. The non-redundant or “normal” patch can include a three-member set. The three-member set can include a server A 412. Server A can be associated with a group such as a group associated with the first communications system. The three-member set can further include servers such as server 1 414 and server 2 416. Server 1 and server 2 can each be associated with a group. In embodiments, the groups can be associated with the second communications system. A connection request can be received to enable a link pair between server A and server 1, or between server A and server 2. The choice of which server from server 1 or server 2 to enable the connection request to server A can be based on patching instructions, server availability, server reliability, channel status (e.g., availability or reliability), etc. The system configuration can be based on a redundancy patch 420. The redundancy patch can enable a link pair between server A 422 and either primary server 1 424 or redundant server 2 426.

In the redundancy patch figure, an active link can be established between server A and primary server 1. The active link can enable the flow of data between servers. In embodiments, the data can include voice data, status data, and metadata. The voice data can include analog voice data, digital voice data, encoded voice data, and so on. In embodiments, the voice data and the metadata can only flow on an active link pair. The status data can include channel status, communication type such as normal communications or mission-critical communications, etc. The metadata can include a group ID, a talker ID, GPS location data, and the like. Further, an inactive link can be coupled between server A and redundant server 2. An inactive link does not necessarily imply that there is no link between server A and redundant server 2. Rather, some data can flow on an inactive link pair. In embodiments, the status data can flow on active and inactive link pairs. The status data on an active link can include link quality, error rates, dropout rates, link reliability, link availability, and the like. The status data on an inactive link can also include link quality, reliability, and availability; error and dropout rates; etc. The choice can be determined as to which link pair to enable, when to switch to a redundant link pair, and so on. In embodiments, the peer-to-peer connectivity can determine active communication channels among the groups. The determining can be based on link availability, communication channel accessibility, etc. In embodiments, the determining can be based on active communication channel availability and communication channel status.

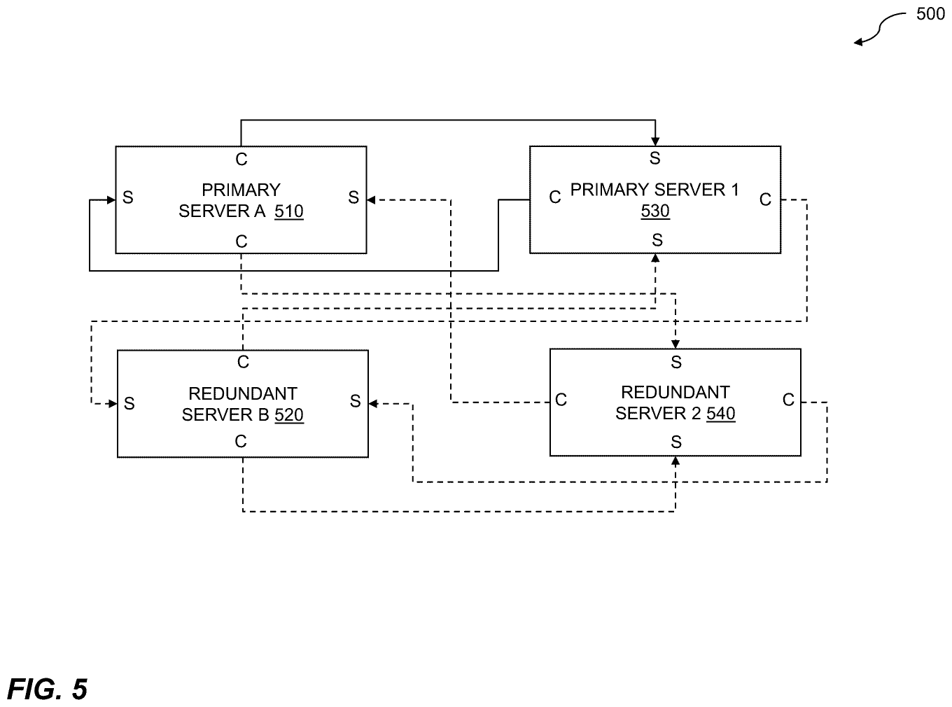

FIG. 5 is system configuration for arbitrating redundancy. Discussed previously and throughout, servers associated with communications systems can be configured to enable redundancy. The redundancy can be accomplished by providing one or more “spare” servers, where a spare can be enabled or “switched in” for use with a communications system. The spare servers can be used to replace an out-of-contact, intermittent, unreliable, or failed server. The spare servers can be configured as cold spares, hot spares, primary and backup systems, and so on. A cold spare is available to be activated for use when a primary channel fails. A hot spare can comprise a spare that can be continuously in operation and be reallocated or retasked. A primary and backup system can include a backup system that can be a duplicate of the primary system. A peer-to-peer server communication-enabled local supervisory switching function running within each server can monitor the primary and backup systems and can determine whether to switch from the primary system to the backup system or from the backup system to the primary system. In a normal, non-failure scenario, a server will be intelligently connected such that there is both a primary and a redundant server, interconnected as a client-server pair. The primary and redundant servers both connect as a communication gateway to the same system and talk path or talkgroup. They are “equals” and either can do the communication gateway “job”. If both primary and redundant servers report as “healthy” and connected, the one that is nominally the “primary” can be set to “active”. If, based on data passed through the client-server connection, anyone of the following issues are present, it will assume that the server/connection is unhealthy/unusable and arbitrate to the other one being active: (i) no connectivity—the client-server connection cannot be established; (ii) local, attached communication gateway offline—he connected server, through the intelligent connection, signals that its attached communication system is unhealthy, not working, or locally disabled; (iii) the primary and redundant do not connect to each other in the first place. All runtime decision-making (after initial setup) for which is server is the active server is made by the supervisory elements running on each server. During the initial configuration, the global administrative element just sets up for each server who its partner primary and redundant servers are. There can be more than two partner servers, but a minimum of two are needed for redundancy arbitration to be required.

Arbitrating redundancy among servers can enable communication networks with redundancy diversity. Push-to-talk (PTT) services are accessed over a first communications system, wherein the first communications system includes at least two homogeneous groups, and wherein the at least two homogeneous groups enable redundancy for the first communications system. Additional push-to-talk (PTT) services are provided over a second communications system, wherein the second communications system implements a different network protocol from the first communications system, and wherein at least one homogeneous group is included in the second communications system. Peer-to-peer connectivity is established between the first communications system and the second communications system. Data for a communication channel is routed between a first group in the first communications system and a group in the second communications system. The data is rerouted between a second group in the first communications system and the group in the second communications system, based on the data and the peer-to-peer connectivity.

The system configuration 500 can include a primary server A 510. The primary server A can be configured to use one or more channels associated with a communications system. The communications system can include a cellular telephony system such as an LTE system, a land mobile radio system (LMR), and so on. In addition to the channel configuration, further configurations can be associated with access codes, data encoding or encryption techniques, etc. The primary server A can be associated with a group such as a homogeneous group. The homogeneous group can be associated with the first communications system. The system configuration 500 can include a redundant server B 520. The redundant server B can be configured substantially similarly to primary server A or can be configured to be substantially different from primary server A. The configuring can include patching instructions. In embodiments, the patching instructions can be provided by a client such as a console. After receiving patching information, servers can coordinate patching operations with peer servers. In embodiments, an administrative element can be used to initially configure the peer-to-peer connectivity. The administrative element can be based on electronic hardware, software, an app, a combination of hardware and software, etc.

The system configuration 500 can include a primary server such as primary server 1 530. The primary server 1 can be associated with a second communications system. The primary server 1 can be configured to operate with the second communications system, where the configuration can include designating channels or frequencies appropriate to the second communications system. The configuration can further include setting up control tones, access codes, encoding techniques, encryption techniques, and so on. The system configuration 500 can further include a redundant server such as redundant server 2 540. The redundant server 2 can be configured substantially similarly to primary server 1, substantially differently, etc. The differences between the configurations can include different channels, wirelines or numbers of wirelines, access to different repeaters, etc.

Recall that each group of a first communications system and each group of a second communications system can include a server with a client link and a server link to each other group. A server associated with the first communications system and the server associated with the second communications system can be linked using the client link and the server link. The client link and the server link can include wired links, wireless links, hybrid links, multiple links, etc. In embodiments, the client link and the server link can include a link pair, where the link pair can enable peer-to-peer connectivity between two groups. A link pair can be enabled between primary server A and the servers primary server 1 and redundant server 2. Similarly, a link pair can be enabled between redundant server B and servers primary server 1 and redundant server 2. One of the link pairs from primary server A can be active between server A and either primary server 1 or redundant server 2. The servers not in use to enable peer-to-peer connectivity between two groups at a given time can remain in idling states. An idling state can be based on a configuration that can be substantially similar to the server to which the active link pair is coupled. If primary server A becomes unavailable, unreliable, or goes down, then a link pair can be enabled between redundant server B and either primary server 1 or redundant server 2.

Functioning link pairs between servers associated with the first communications system and servers associated with the second communications system can include an active link pair and inactive pairs. Further link pairs may be broken, intermittent, unavailable, etc. Data can be transferred between groups associated with servers. In embodiments, the data can include voice data, status data, and metadata. Depending on whether a given link is active or inactive, various types of data can flow between servers. In embodiments, the voice data and the metadata can only flow on an active link pair. The voice data and the metadata are necessary to support communications between a group associated with the first communications system and the group associated with the second communications system. Status data can flow with less restriction. In other embodiments, the status data can flow on active and inactive link pairs. The status data can include link pair status such as active or inactive, can indicate a link error rate, etc.

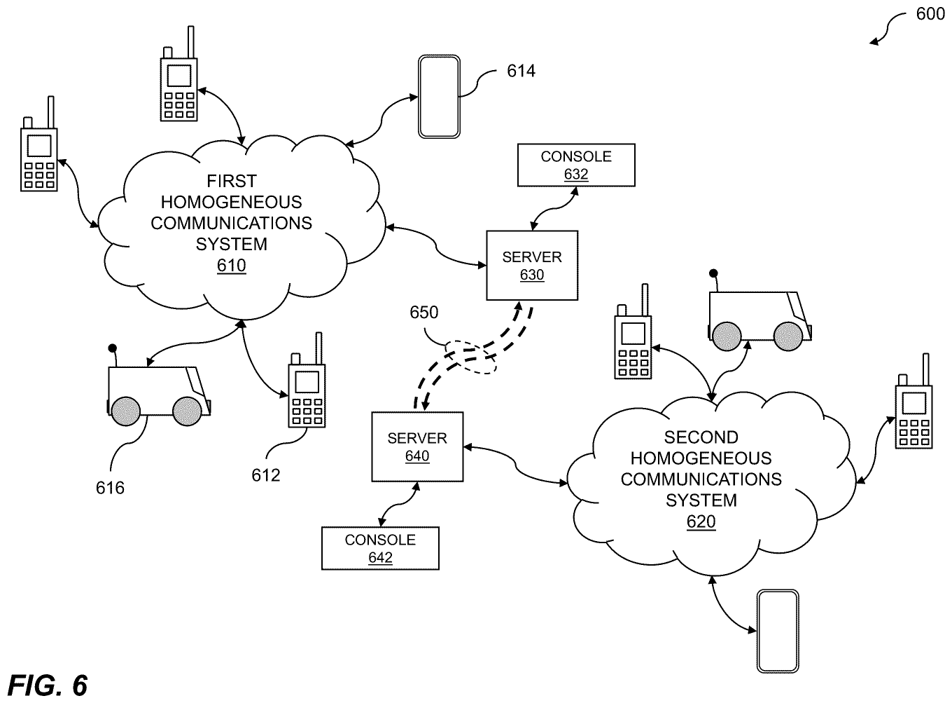

FIG. 6 is an infographic for a first and second homogeneous communications system. Discussed previously and throughout, redundancy diversity can enable routing data for a communication channel between homogeneous groups in communications system. Further, rerouting of the data can be accomplished based on communication channel availability and status, server availability, and so on. Each group of a first communications system and each group of a second communications system can include a server with a client link and a server link to each other group. The links can include wired, wireless, and hybrid links. The client link and the server link can include a link pair, where the link pair can enable peer-to-peer connectivity between two groups. The groups, which can each provide push-to-talk (PTT) services, can include homogeneous communications techniques such as LTE, LMR, or the like. The homogeneous communications system is enabled by communication networks with redundancy diversity. Push-to-talk (PTT) services are accessed over a first communications system, wherein the first communications system includes at least two homogeneous groups, and wherein the at least two homogeneous groups enable redundancy for the first communications system. Additional push-to-talk (PTT) services are provided over a second communications system, wherein the second communications system implements a different network protocol from the first communications system, and wherein at least one homogeneous group is included in the second communications system. Peer-to-peer connectivity is established between the first communications system and the second communications system. Data for a communication channel is routed between a first group in the first communications system and a group in the second communications system. The data is rerouted between a second group in the first communications system and the group in the second communications system, based on the data and the peer-to-peer connectivity.

The infographic 600 can include a first homogeneous communications or “comms” system 610. The first communications system can provide services such as push-to-talk (PTT) services. The push-to-talk services can include half-duplex, repeater, or similar operations. The communications system can use one or more frequency bands to enable communication. In embodiments, the communications system can be based on low-VHF, VHF, UHF, and similar bands. The bands that are used can include licensed and unlicensed spectra. The communications system can include one or more communications modes such as FM, narrowband FM, and so on. The communications modes can be based on analog or digital techniques. Various types of user devices can be associated with the first communications system. The infographic 600 can include a first user device 612. The first user device can be used by an individual to communicate with another individual, with a group such as a talk group, and so on. The communication can include audio, text, video, and the like, depending on the capabilities of the first user device. The first user device includes a handheld transceiver (HT) or “walkie talkie”. The HT can be configured to connect to the first communications system. In embodiments, the HT can connect to the communications system using one or more power levels, channels or frequencies, access tones or codes, and so on. When a plurality of users accesses the first communications system, more than one HT or other user device can connect to the first communications system. In other embodiments, the first device can include a telephonic device such as a smartphone 614. A transceiver (not shown) can be coupled to the smartphone to connect to the first communications system. A transceiver app can be loaded onto the smartphone, where the app enables the smartphone to access the first communications system. In further embodiments, the first device can include a mobile transceiver 616. The mobile transceiver can be mounted in a vehicle such as a car, van, or truck; an aircraft such as a plane, helicopter, drone, or balloon; etc. One or more user devices of one or more user device types can be connected to the first communications system.

The various devices that are configured to access the first communications system can communicate among themselves. The communications within the first communications system can include one-to-one communication, where a first user device connects to a second user device. The communications within the first communications system can further include one-to-many communication, many-to-many communication, and so on. The communication among more than two user devices can include communication within a talk group. The user devices associated with a communications system such as the first communications system can communicate between and among themselves using a repeater, two or more linked repeaters, etc. The infographic 600 can include a second homogeneous communications system 620. The second communications system can be substantially similar to or substantially different from the first communications system. The first communications system and the second communications systems can include LMR, LTE, or other communications systems. In embodiments, the first communications system and the second communications system are operated independently. The independently operated communications systems can be operated by governmental or emergency services, commercial enterprises, trained amateur operators, etc. Various user devices can communicate using the second communications system. The devices can include one or more user device types. The user device types can include HTs, smartphones coupled to transceivers, smartphones loaded with apps that enable communication using the second homogeneous communications system, mobile user devices, etc.

The first communications system can include at least two homogeneous groups. The homogeneous groups can be based on a similar communications technique, where the communications technique can include LTE, LMR, and so on. The homogeneous groups can include a variety of user devices such as HTs, mobile units, telephones, etc., where each user device is able to access the communications system. While the two homogeneous groups can be based on a substantially similar communications technique, the groups can include substantially similar channels and configurations or substantially different channels and configurations. The second communications system can include at least one homogeneous group. In embodiments, each group of the first communications system and each group of the second communications system can include a server such as server 630 and server 640, respectively. Each server can include a client link and a server link to each other group. The client link can be used to communicate with a peer server, where the peer server is used for providing patches, and for configuring an N-member server group, where N can include the number of servers. The server link can be used to receive status information from an active member of the server group. Each server can be in communication with a console such as console 632 and console 642. The console can be used to provide configuration information such as communications channels, protocol configuration, and so on. In embodiments, the client link and the server link can comprise a link pair 650. The link pair can be used to send and receive status information such as server status information. In embodiments, the link pair can enable peer-to-peer connectivity between two groups. The two groups can be associated with a communications system. In embodiments, the two groups are associated with different communications groups. Various types of data can be routed across a link pair. In embodiments, the data can include voice data, status data, and metadata. Some of the data that is routed can only be routed across an active link pair. In embodiments, the voice data and the metadata can only flow on an active link pair. Other data can flow on either an active link pair or an inactive link pair. In other embodiments, the status data can flow on active and inactive link pairs.

Other types of data can be communicated between groups using the link pair. In embodiments, the data can include a text message, individual voice call, talkgroup voice call, information message, etc. The link pair can be enabled using a network, a back channel, one or more leased lines, the Internet, and so on. The channel can include a wired, wireless, or hybrid wired-wireless channel. The channel can include redundant communications paths. The data can include an information message. In embodiments, the information message can include a text message. The text message can include a Talker ID associated with a user device using the first communications system. In embodiments, receiving the data and a message such as the text message can be accomplished by a client application running on the second user device, a PTT client, and so on. The received data and the message can be displayed on a device coupled to a display. The device can include a user device associated with the second communications system. The message can be used to provide key information such as Talker ID information associated with the first user device. In embodiments, the displaying can further include replacing, by the client application running on the second user device, an ordinary user ID from the first communications system with the Talker ID associated with the first user device. In embodiments, the first communications system 610 can be considered to include attached devices such as the first user device 612, the smartphone 614, the mobile transceiver 616, etc. In embodiments, the second communications system 620 can be considered to include attached devices such as user devices, smartphones, mobile transceivers, etc. In this manner, the link 650 enables communication between the first communications system 610 and the second communications system 620.

Messaging can be used to provide Talker ID routing between communications systems as described. Numerous communications scenarios exist in which a plurality of agencies require communications within each agency and between one or more additional agencies. Such scenarios include natural disasters, political unrest, terrorist attacks, and so on. Agencies such as public safety, emergency services, and government agencies must coordinate their responses to a given situation. Traditionally, interoperability between agencies was discouraged so as to avoid spurious communications by unauthorized personnel, to maintain channel integrity or security, and so on. However, after massive terrorist events such as September 11 in the United States, July 11 in Great Britain, and the November 2015 Paris attacks; and natural disasters such as Hurricane Katrina; an inability to communicate between and among agencies further complicated already complex situations. As a result, the ability to communicate among agencies became paramount. Complete replacement of existing communications system was too expensive, so the ability to provide inter-communication system connectivity was sought instead. While users of different communications systems can be interconnected, key data such as Talker ID data is made generic, obscured, or even lost. In disclosed embodiments, information messages containing useful data such as Talker ID data and GPS data can be provided by one communications system to a second communications system. The information message can be provided without requiring a deep connection and an extensive system-to-system interface.

Communication information, including voice and state information such as emergency or mission-critical information, can be routed from a first communications system to a second communications system. Access between these communications systems can be accomplished by an ordinary user, which successfully enables communications but does not provide key information such as Talker ID. Providing Talker ID of the talking on the originating system (TOS) is highly desirable since such data confirms identify of a talker, enables access, and the like. A typical client user device such as a Third-Generation Partnership Project (3GPP)-compliant client can be used on a mission-critical push-to-talk (MCPTT) communications system. In embodiments, the 3GPP on an MCPTT communications system can make voice calls, can send text messages, and can send data messages such as mission-critical data (MCData) messages. The voice calls, text messages, and MCData messages can be sent to an individual, a talk group, and so on. These voice and data capabilities can enable sharing of Talker ID and other information between communications systems.

In a usage example, an individual accessing one communications system can initiate a call to an individual or a talk group in a second communications system. The call can be enabled by a typical 3GPP-client client. The 3GPP-compliant client can send an information message substantially simultaneously. In embodiments, the communication message, which can include a text message, can include the TOS information described above. The call and the text message can be received and displayed using hardware techniques, software techniques, and so on. In embodiments, an unmodified MCPTT client can have access to the data in the text message. The data can be rendered on a display associated with the MCPTT client. In further embodiments, an MCPTT client app can be used on various devices such as HTs, smartphones, and so on. The MCPTT client app can recognize that the text message contains TOS information, can suppress the message from being shown along with other standard text messages, and can “spoof” the Talker ID with the TOS data. The spoofing the Talker ID enables display of an actual Talker ID rather than a generic or “common” user Talker ID. The 3GPP-compliant client can also send an MCData message that includes the TOS information.

Further information can be sent from one communications system to a second communications system when initiating a 3GPP-compliant call, a text message, and so on. In embodiments, the further information can include global positioning system (GPS) data. The GPS data can include latitude and longitude information. The GPS data can include representation of the location of one or more user devices, where the representation can be unreadable by a human user. An app can be used to convert the GPS data into a usable format. The usable format can include rendering latitude and longitude using degrees, minutes, and seconds; decimal degrees such as Latitude: 43.893978 Longitude: −72.088991; and so on. The using a GPS format can include using the GPS coordinates to pin a location on a map. The map can include a standard map, a road map, a hybrid map, a contour map, a satellite map, and the like.

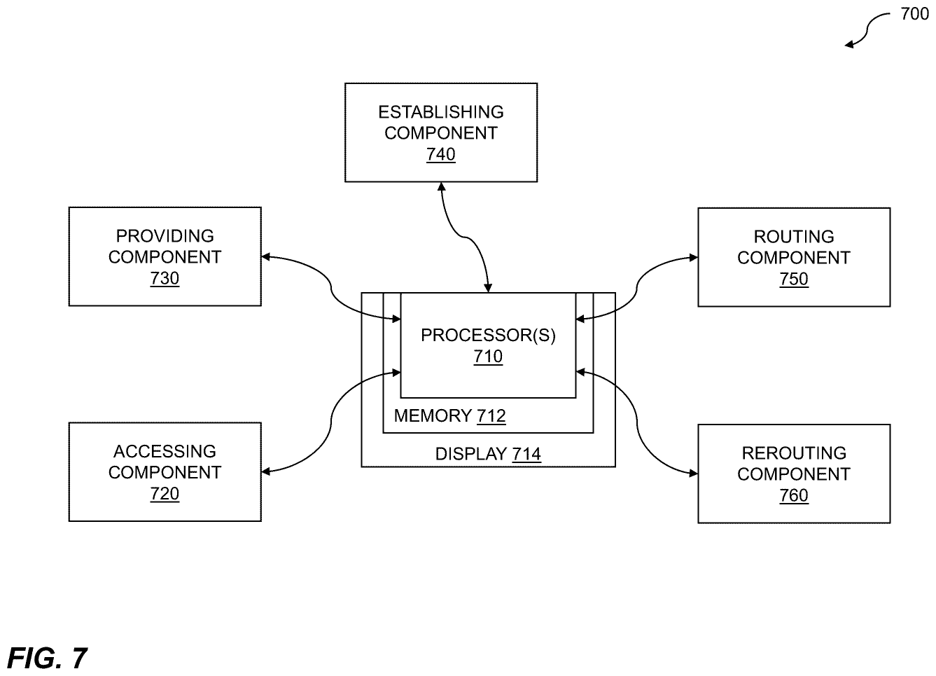

FIG. 7 is a system diagram for communications. The communications are enabled by networks with redundancy diversity. The system 700 can include one or more processors 710, which are attached to a memory 712 which stores instructions. The system 700 can further include a display 714 coupled to the one or more processors 710 for displaying data such as voice data information, status data such as status associated with one or more link pairs, metadata, emergency information, talker IDs, GPS data, and so on. In embodiments, one or more processors 710 are coupled to the memory 712, wherein the one or more processors, when executing the instructions which are stored, are configured to: access push-to-talk (PTT) services over a first communications system, wherein the first communications system includes at least two homogeneous groups, and wherein the at least two homogeneous groups enable redundancy for the first communications system; provide additional push-to-talk (PTT) services over a second communications system, wherein the second communications system implements a different network protocol from the first communications system, and wherein at least one homogeneous group is included in the second communications system; establish a peer-to-peer connectivity between the first communications system and the second communications system; route data for a communication channel between a first group in the first communications system and a group in the second communications system; and reroute the data between a second group in the first communications system and the group in the second communications system, based on the data and the peer-to-peer connectivity.

The system 700 can include an accessing component 720. The accessing component 720 can include logic and functions for accessing push-to-talk (PTT) services over a first communications system, wherein the first communications system includes at least two homogeneous groups, and wherein the at least two homogeneous groups enable redundancy for the first communications system. The PTT services can include a simplex operation, a half-duplex operation, full duplex operations, one-to-many operations, a talk group, and so on. The first communications system can include a wireless communications system such as a land mobile radio (LMR) communications system. The LMR communications system can enable government and emergency services, enterprises, government, and personal communications, etc. The wireless communications system can be based on low-VHF frequencies, VHF frequencies, UHF frequencies, SHF frequencies, and so on. The system can access licensed and unlicensed communications bands. The system can be based on one or more power levels including a maximum power level for the bands.

The communications systems can include analog modes such as FM and narrow band FM, digital modes such as Next Generation Digital Narrowband (NXDN™), Project 25 (P25), and the like. In embodiments, the communications channels can include encrypted and unencrypted communications. The at least two groups associated with the first communications system can include groups based on cellular communications, groups based on mobile communications, and so on. Cellular groups can be based on Long Term Evolution (LTE), 5G, and the like. Mobile groups can be based on Land Mobile Radio (LMR). The at least two groups can include redundant groups, where at least one group is active while the other group is inactive. The at least one group can include two or more active groups. A group included in the first communications system can communicate with a group in a second communications system. Devices such as user devices that can access the first communications system can include handheld devices such as handheld transceivers (HTs) or walkie-talkies, mobile transceivers, repeaters, cross-band transceivers, base stations, etc. The user devices can also include telephonic devices such as a smartphone, where the smartphone can be loaded with a communications app or similar software. In embodiments, the first user device can be Third Generation Partnership Project (3GPP)-compliant. 3GPP-compliance can enable radio access technologies such as Universal Terrestrial Radio Access™ (UTRA), Frequency Division Duple (FDD), etc.

The system 700 can include a providing component 730. The providing component 730 can include logic and functions for providing additional push-to-talk (PTT) services over a second communications system, wherein the second communications system implements a different network protocol from the first communications system, and wherein at least one homogeneous group is included in the second communications system. The PTT services provided by the second communications system can be substantially similar to or substantially different from the PTT services provided by the first communications system. The second communications system can include a wireless communications system such as an LMR communications system, an LTE or 5G communications system, etc. The LMR communications system can enable communications among substantially similar groups to those groups associated with the first communications system, substantially different groups, and the like. The second communications system can use channels substantially similar to or substantially different from channels used by the first communications system. In a usage example, the first communications system can be based on an LTE communication technique and the second communications system can be based on an LMR technique. More than one LMR standard can be used by groups associated with the example second communications system.

The system 700 can include an establishing component 740. The establishing component 740 can include logic and functions for establishing a peer-to-peer connectivity between the first communications system and the second communications system. The peer-to-peer connectivity between the first communications system and the second communications system can establish user device to user device connectivity, one device to many devices connectivity, talk groups that span the two communications systems, etc. Peer-to-peer connectivity can be established through one or more links. In embodiments, each group of the first communications system and each group of the second communications system can include a server with a client link and a server link to each other group. The server can include a computing component such as a processor and a network connection. The network connection can include an Internet Protocol (IP) network. The IP network can include a wired network, a wireless network, and so on. In embodiments, the client link can include a console such as an operator console. The client link and the server link can enable connectivity between groups within a communications system, between a group in the first communications system and a group within the second communications system, etc. In embodiments, the client link and the server link comprise a link pair. The link pair can be enabled using wired techniques, wireless techniques, hybrid wired and wireless techniques, etc. In embodiments, the link pair can enable peer-to-peer connectivity between two groups. Various types of data can be carried by a link pair. In embodiments, the data can include voice data, status data, and metadata. The status data can be associated with a communications channel. The metadata can include routine or mission-critical information, Talker ID, GPS location, and so on.

The system 700 can include a routing component 750. The routing component 750 can include logic and functions for routing data for a communication channel between a first group in the first communications system and a group in the second communications system. The routing can be accomplished using a link pair. Recall that the link pair can enable peer-to-peer connectivity between two groups. The two groups can be associated with different communications systems, where the communications systems can be based on different communications techniques such as LTE, LMR, and so on. More than one link pair can be available for routing data between the first group and the second group. In embodiments, the voice data and the metadata can only flow on an active link pair. Other link pairs, if present, can include spare links, backup links, and the like. The spare links, backup links, etc., can be associated with communications channels. A spare communications channel can include a cold spare. One or more cold spare channels can be available for use. A cold spare channel can be configured by an administrator and can be used to manually replace a failed channel. A hot spare communications channel can include an already configured and operating channel. The hot spare can be manually switched into use. A backup link can include a substantially similar communications system to a first or primary communications system. A component such as a local supervisory switching component distributed among servers can reroute communications between a first communications system and one or more additional communications systems, based on data transmitted along the peer-to-peer connectivity.

The routing data between a group in the first communications system and a group in the second communications system can include sending various types of data associated with a communication between the groups. The communication can include data such as alphanumeric data, audio data such as continuous tone-coded squelch system (CTSS) tones, and the like. In embodiments, the communication can include a text message, an individual voice call, a talkgroup voice call, etc. The second user device can be substantially similar to the first user device or substantially different from the first user device. The second user device can include a handheld device, a mobile device, and a base station or stationary device. The second user device can include a smartphone or other telecommunication device. The second communications system can be substantially similar to or substantially different from the first communications system. In embodiments, the first communications system and the second communications system can be based on Land Mobile Radio technology (LMR). Discussed previously, the LMR radio technology can be based on VHF and UHF frequencies, can include analog and digital modes, and so on. In embodiments, the first communications system is based on LTE technology and the second communications system is based on LMR technology. The LTE technology can include 5G technology. The first communications system and the second communications system can further be based on GSM technology, VHF marine radio, satellite communications, etc. In further embodiments, the first communications system is based on LMR technology, and the second communications system is based on LTE technology. The sending a communication enables a connection among a plurality of user devices. In embodiments, the sending a communication can include a talk group on the second communication system.

In embodiments, the data routed between the first communications system and the second communications system can include an information message. The information message can be routed between a first user device and a second user device. In embodiments, the information message can include a Talker ID, mission-critical information, and so on. The information can include one or more characters such as alphanumeric characters. In embodiments, the information message can include a text message. The number of alphanumeric characters in the information message can include a fixed or variable number of characters, a limited number of characters, and so on. The information message can be based on one or more text message standards. In embodiments, the information message can include a mission critical data (MCData) message. An MCData service can include messaging data, transferred file data, streaming data, and the like. An MCData service can, in addition to providing various data types, also provide conversation management between individuals and talk groups, database inquiries, internet and intranet access, etc.

The routing data can send the data to a user device. The user device can receive the data and an information message. The user device can include a handheld, mobile, or base station device, a smartphone, etc. The data and the information message can be directed or routed specifically to the user device, to a device among a talk group of devices, to a talk group, and so on. The data and the information message can be received by a device designed for use with the second communications system, using software running on the device, and so on. In embodiments, the receiving the data and the information message can be accomplished by a client application running on the user device. The client application can be downloaded from an application service or store, provided by an operator of the second communications system, provided by a governmental or emergency services agency, etc. In embodiments, the receiving the data and the information message can be accomplished by a standard PTT client. The standard PTT client can be designed for one or more communications systems such as the second communications system. The information message can include an MCData message. In embodiments, the receiving the data and the information message can be accomplished by a client application running on the second user device. The application can be used to recognize that the information message is an MCData message. Embodiments further include recognizing, by the client application, if the MCData message includes the information such as a Talker ID. The recognizing can be used for displaying purposes, discussed below. In embodiments, the receiving the communication and the information message is accomplished by a standard PTT client. The information message received by the standard PTT client can include an MCData message.

The system 700 can include a rerouting component 760. The rerouting component 760 can include logic and functions deployed locally on each server with peer-to-peer connectivity for rerouting the data between a second group in the first communications system and the group in the second communications system, based on the data and the peer-to-peer connectivity. In the event that a primary, preferred, and similar link becomes unavailable, unreliable, intermittent, etc., a spare or backup system can be switched in to replace the failed link. The switching can be performed automatically based on the peer-to-peer connectivity and a switching function running autonomously within each server. In embodiments, the peer-to-peer connectivity can determine active communication channels among the groups. The active communication channels can include assigned channels, special or reserved channels available for mission-critical communication, and so on. In embodiments, the communication channel status can include information about a group connected to the communication channel. The information about a group can include a group classification such as government, emergency services, or civilian; a group ID such as a group name, code name, letter or number; etc. In embodiments, the rerouting can provide a redundant communication channel. Redundant communication channels are highly desirable because they can be switched into use based on a primary channel failure, channel congestion, manmade interference (QRM) such as intermodulation or jamming, natural interference (QRN) such as lightning, signal fading due to weather, etc.

In embodiments, the peer-to-peer connectivity and the rerouting can enable PTT redundancy diversity. The redundancy as discussed previously can include redundant groups, links, communication channels, and so on. The diversity can include access to different towers such as LTE or LMR towers, different LMR configurations, different wireline links, and so on. In a usage example, consider a donor radio that can be pointed to different LMR towers, either towers that are part of a homogenous LMR network like a P25 statewide system or different towers, like a neighbor's LMR system which could be a different frequency band, protocol, encryption key, etc. In the case of the multi-site LMR network, a single donor radio can be used to back up connections to any one of several towers. For instance, Tower 1 might go dark, necessitating the need to point the radio to Tower 2 and hence restore connectivity to the larger LMR radio network. Alternatively, Tower 1 might become orphaned; in this case the donor radio could be pointed to Tower 1 and patched to another donor radio pointing to Tower 2 such that LMR communications are restored on one LMR talk group (TG). This technique can implement redundancy components that use a different technology (Control Stations) to back up a limited number of wireline talkgroup failures. Backing up the talkgroup features can be accomplished by manually initiating use of a different technology. Such a technique generally requires intimate system knowledge (tower channels, locations, and coverage) to apply successfully.

The system 700 can include a computer program product embodied in a non-transitory computer readable medium for communications, the computer program product comprising code which causes one or more processors to perform operations of: accessing push-to-talk (PTT) services over a first communications system, wherein the first communications system includes at least two homogeneous groups, and wherein the at least two homogeneous groups enable redundancy for the first communications system; providing additional push-to-talk (PTT) services over a second communications system, wherein the second communications system implements a different network protocol from the first communications system, and wherein at least one homogeneous group is included in the second communications system; establishing a peer-to-peer connectivity between the first communications system and the second communications system; routing data for a communication channel between a first group in the first communications system and a group in the second communications system; and rerouting the data between a second group in the first communications system and the group in the second communications system, based on the data and the peer-to-peer connectivity.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software -as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for communications comprising:
accessing push-to-talk (PTT) services over a first communications system, wherein the first communications system includes at least two homogeneous groups, and wherein the at least two homogeneous groups enable redundancy for the first communications system;
providing additional push-to-talk services over a second communications system, wherein the second communications system implements a different network protocol from the first communications system, and wherein at least one homogeneous group is included in the second communications system;
establishing a peer-to-peer connectivity between the first communications system and the second communications system;
routing data for a communication channel between a first group in the first communications system and a group in the second communications system; and
rerouting the data between a second group in the first communications system and the group in the second communications system, based on the data and the peer-to-peer connectivity.

2. The method of claim 1 wherein each group of the first communications system and each group of the second communications system comprises a server with a client link and a server link to each other group.

3. The method of claim 2 wherein the client link and the server link comprise a link pair.

4. The method of claim 3 wherein the link pair enables peer-to-peer connectivity between two groups.

5. The method of claim 3 wherein the data comprises voice data, status data, and metadata.

6. The method of claim 5 wherein the voice data and the metadata only flow on an active link pair.

7. The method of claim 5 wherein the status data flows on active and inactive link pairs.

8. The method of claim 1 wherein the peer-to-peer connectivity determines active communication channels among the groups.

9. The method of claim 8 wherein the determining is based on active communication channel availability and communication channel status.

10. The method of claim 8 wherein the rerouting occurs due to a change in communication channel availability or communication channel status.

11. The method of claim 10 wherein the communication channel status includes information about a group connected to the communication channel.

12. The method of claim 10 wherein the rerouting provides a redundant communication channel.

13. The method of claim 10 wherein the peer-to-peer connectivity and the rerouting enable PTT redundancy diversity.

14. The method of claim 1 further comprising at least two homogeneous groups in the second communications system.

15. The method of claim 14 wherein the at least two homogeneous groups in the first communications system and the at least two homogeneous groups in the second communications system enable dynamic, multi-system redundancy.

16. The method of claim 1 further comprising an administrative element to initially configure the peer-to-peer connectivity.

17. The method of claim 1 wherein the first communications system comprises homogeneous groups each based on cellular protocols.

18. The method of claim 17 wherein the cellular protocols include long-term evolution (LTE) protocols.

19. The method of claim 17 wherein the second communications system comprises homogeneous groups each based on Land Mobile Radio (LMR) protocols.

20. The method of claim 19 wherein the homogeneous groups based on LMR protocols include systems from two or more different vendors.

21. The method of claim 17 wherein the second communications system comprises homogeneous groups each based on near field communication protocols.

22. A computer program product embodied in a non-transitory computer readable medium for communications, the computer program product comprising code which causes one or more processors to perform operations of:
accessing push-to-talk (PTT) services over a first communications system, wherein the first communications system includes at least two homogeneous groups, and wherein the at least two homogeneous groups enable redundancy for the first communications system;
providing additional push-to-talk services over a second communications system, wherein the second communications system implements a different network protocol from the first communications system, and wherein at least one homogeneous group is included in the second communications system;
establishing a peer-to-peer connectivity between the first communications system and the second communications system;
routing data for a communication channel between a first group in the first communications system and a group in the second communications system; and
rerouting the data between a second group in the first communications system and the group in the second communications system, based on the data and the peer-to-peer connectivity.

23. A computer system for communications comprising:
a memory which stores instructions;
one or more processors attached to the memory wherein the one or more processors, when executing the instructions which are stored, are configured to:
access push-to-talk (PTT) services over a first communications system, wherein the first communications system includes at least two homogeneous groups, and wherein the at least two homogeneous groups enable redundancy for the first communications system;
provide additional push-to-talk services over a second communications system, wherein the second communications system implements a different network protocol from the first communications system, and wherein at least one homogeneous group is included in the second communications system;
establish a peer-to-peer connectivity between the first communications system and the second communications system;
route data for a communication channel between a first group in the first communications system and a group in the second communications system; and
reroute the data between a second group in the first communications system and the group in the second communications system, based on the data and the peer-to-peer connectivity.
